(19) United States
(12) Patent Application Publication
(10) Pub. No.: US 2008/0238974 A1
(43) Pub. Date: Oct. 2, 2008

(54) Droplet ejection device

(75) Inventor: Yoshikazu Takahashi, Nagoya-shi (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: Brother Kogyo Kabushiki Kaisha

(21) Appl. No.: 12/079,439

(22) Filed: Mar. 27, 2008

(30) Foreign Application Priority Data
Mar. 30, 2007 (JP) 2007-090265

(51) Int. Cl. B41J 29/38

(52) U.S. Cl. 347/14

(57) ABSTRACT

A droplet ejection device includes: an ejection head having an actuator and a nozzle; an interface configured to receive data; and a controller configured to (a) execute, based on the received data, ejection control in which liquid droplets having respective different volumes are selectively ejected from the nozzle to a medium by driving the actuator and (b) execute recovery control in which ejection performance of the recording head is recovered by driving the actuator. The controller is configured to (c) determine, based on the received data, a volume of a droplet to be first ejected from the nozzle under the ejection control subsequent to the recovery control, and (d) set, based on the determined volume, a condition for driving the actuator to execute the recovery control.

### CROSS REFERENCE TO RELATED APPLICATION

The present disclosure relates to the subject matter contained in Japanese patent application No. 2007-090265 filed on Mar. 30, 2007, which is expressly incorporated herein by reference in its entirety.

### TECHNICAL FIELD

The present invention relates to a droplet ejection device capable of ejecting droplets, and more particularly to control for preventing an ejection failure, which would otherwise be caused as a result of drying of liquid in the vicinity of nozzles.

### BACKGROUND ART

An ink jet printer is one of embodiments of a droplet ejection device. The inkjet printer is configured such that a drive pulse is applied to a piezoelectric actuator to change the volume of pressure chambers filled with ink and communicating with nozzles of a recording head when the recording head reciprocally scans a record area of a recording medium. This way, the ink jet printer ejects ink droplets from the nozzles of the recording head to the recording medium.

Such a recording head that performs recording by ejecting ink from nozzles suffers from a problem in that a solvent (water or the like) in ink is gradually dried to increase viscosity of ink in nozzles that have few chance to perform ejection or in nozzles when recording operation is suspended. As a result, there arises failures such as a decrease in the size of ink droplets or an ink ejection failure that ink is hardly ejected. These failures deteriorate recording image quality.

In order to avoid such deterioration of recording performance, the ink jet printer performs preliminary ejection (so-called flushing), before commencement of recording operation or in the middle of recording operation, by periodically or forcefully moving the recording head to a flushing receiving section disposed in a non-recording area outside a recording area, and then applying drive pulses to actuators to forcefully eject ink from all of the nozzles (see, for example, JP-A-2002-036594, paragraph numbers 0021 and 0042 to 0047, and FIGS. 1 and 3).

Another proposal is to perform drying prevention driving. After completion of recording operation, a pulse group including plural non-ejection drive pulses is applied to an actuator vibrate meniscuses of liquid in the vicinity of nozzles to such an extent as not to eject droplets from the nozzles. When the following recording operation is not performed even after a predetermined period of time has elapsed since recording operation ended, foregoing flushing is performed (see, for example, JP-A-09-029996, paragraph numbers 0018 to 0026, and FIGS. 4 and 5).

Recovery operation, such as non-ejection driving or flushing, is necessary from the viewpoint of preventing drying, which would otherwise be caused as a result of elapse of a time since previous ejecting operation. However, the recovery operation has hitherto been performed indiscriminately regardless of specifics of ejecting operation. Namely, when the volume of droplets to be ejected is comparatively large, energy acting on a liquid at the time of ejecting operation is large. Therefore, even when the viscosity of the liquid has slightly increased, the liquid can be ejected from the nozzles. On the other hand, when the volume of droplets to be ejected is small, an increase in the viscosity of the liquid greatly affects ejection. Therefore, in the former case, energy for recovery operation may also be reduced, or the cycle of performing recovery operation may also be made longer. However, in the latter case, energy for recovery operation must be increased, or the cycle of performing recovery operation must be shortened. Therefore, conditions for flushing or drying prevention driving (non-ejection driving) are set on the assumption that the volume of droplets to be ejected in the next ejection operation would be small. Therefore, wasteful consumption of a liquid and wasteful consumption of power associated with drying prevention driving have hitherto been performed, which impairs economy.

### SUMMARY

In view of the above-noted circumstances, the present invention can provide, as one of illustrative, non-limiting embodiments, a droplet ejection device which includes: an ejection head having an actuator and a nozzle; an interface configured to receive data; and a controller configured to (a) execute, based on the received data, ejection control in which liquid droplets having respective different volumes are selectively ejected from the nozzle to a medium by driving the actuator and (b) execute recovery control in which ejection performance of the recording head is recovered by driving the actuator. The controller is configured to (c) determine, based on the received data, a volume of a droplet to be first ejected from the nozzle under the ejection control subsequent to the recovery control, and (d) set, based on the determined volume, a condition for driving the actuator to execute the recovery control.

Accordingly, one of advantages of the present invention is capable of providing a droplet ejection device enhancing economy.

Another one of the advantages of the present invention is capable of setting a condition for recovery control based on a volume of a droplet ejected first under a subsequent ejection control.

Yet another one of the advantages of the present invention is capable of reducing wasteful recovery operation to save liquid consumption and power consumption.

These and other advantages of the present invention will be discussed in detail with reference to the accompanying drawings.

### BRIEF DESCRIPTION OF THE DRAWINGS

FIG. 1 is a plan view showing the general configuration of an inkjet printer that is an embodiment of a droplet ejection device.

FIG. 2 is a cross-sectional view of a recording head.

FIG. 3 is a block diagram showing an electrical control system of the inkjet printer.

FIG. 4 is a diagram showing the internal configuration of a drive circuit.

FIG. 5A is a flowchart showing the flow of control performed in a first example, and FIG. 5B is a descriptive view of a drying prevention waveform.

FIG. 6A is a flowchart showing the flow of control performed in a second example.

FIG. 7A is a flowchart showing the flow of control performed in a third example, and FIGS. 7B and 7C are descriptive views of a drying prevention waveform.

FIG. 8A is a flowchart showing the flow of control performed in a fourth example, and FIGS. 8B and 8C are descriptive views of a drying prevention waveform.

FIG. 9A is a flowchart showing the flow of control performed in a fifth example, and FIGS. 9B, 9C, and 9D are descriptive views of a drying prevention waveform.

### DESCRIPTION OF THE PREFERRED EMBODIMENT

Illustrative, non-limiting embodiments of the present invention will be described hereunder by reference to the drawings.

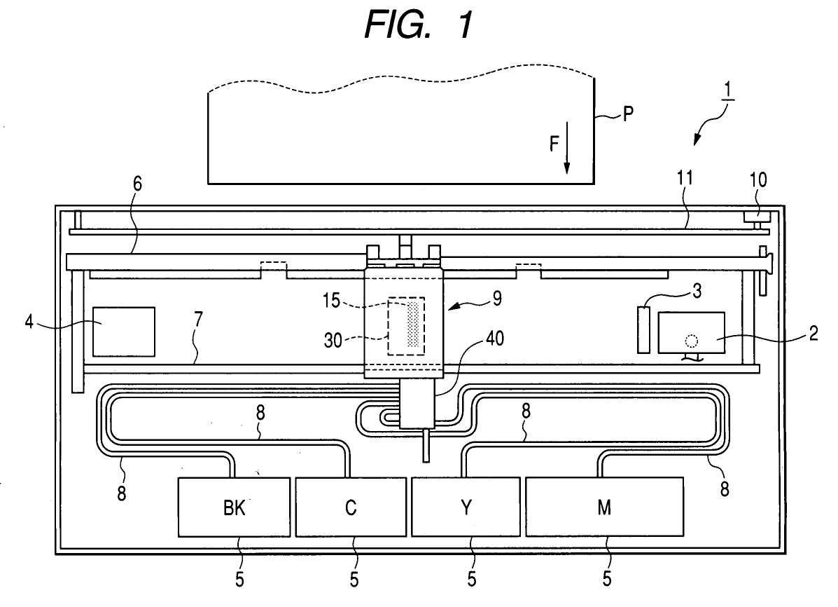

FIG. 1 is a plan view showing the general configuration of an inkjet printer which is an embodiment of a droplet ejection device. In the following descriptions, a side of the inkjet printer, to which ink is ejected, is taken as a lower surface or a downward direction, and an opposite side of the same is taken as an upper surface or an upward direction. In FIG. 1, a left side of the printer is taken as a leftward direction, and a right side of the same is taken as a rightward direction. A lower end side of the inkjet printer in the drawing is taken as the front, and an upper end side of the same is taken as the rear.

As shown in FIG. 1, two guide shafts 6 and 7 are provided in parallel within the inkjet printer 1, and a carriage 9 is slidably supported by the guide shafts 6 and 7. The carriage 9 is equipped with a recording head 30 for subjecting a recording sheet P, which is a recording medium, to recording by ejecting ink from nozzles 15. An ink tank 40 storing colors of ink is mounted on the carriage 9.

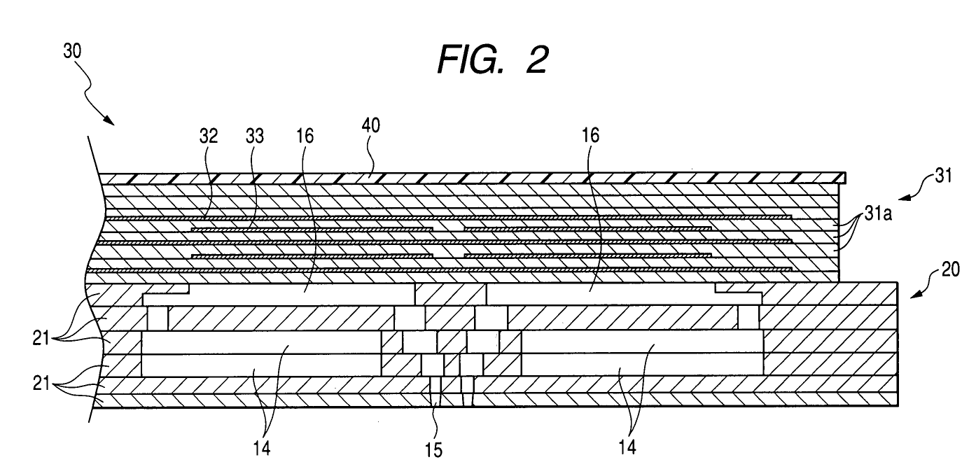

The carriage 9 is fixed to an endless belt 11 rotationally driven by a motor 10. By driving operation of the motor 10, the carriage 9 reciprocally scans the recording sheet P in the widthwise direction thereof (a horizontal direction) along the guide shafts 6 and 7. The recording sheet P is conveyed in a direction (a direction of arrow F) orthogonal to the scanning direction by a conveying device (not shown) provided in the inkjet printer 1. A drive pulse is applied to an actuator 31 (see FIG. 2) of the recording head 30 to eject ink from the nozzles 15 while the carriage 9 is reciprocally scanning the recording sheet P in the widthwise direction (the horizontal direction) thereof, whereby the recording sheet P is subjected to recording by ink.

The inkjet printer 1 has ink cartridges 5 storing therein colors of ink, for example, four colors of ink; namely, black BK, cyan C, magenta M, and yellow Y. The ink cartridges 5 are connected to an ink tank 40 by way of ink supply tubes 8 having flexibility. Ink is stored on a per-color basis within the ink tank 40, and ink is supplied to the respective nozzles 15 color by color.

A flushing receiving member 4 is provided in a non-recording area adjacent to the left side of a recording area (i.e., a widthwise area of the recording sheet P). The flushing receiving member 4 includes a tank and a porous ink-absorbing member (e.g., urethane foam) accommodated in the tank for receiving and absorbing wasted ink ejected from the recording head 30. The recording head 30 carried by the carriage 9 is periodically or forcefully moved to a recovery position opposing the flushing receiving member 4 before commencement of recording operation or in the middle of recording operation, and ink is ejected from the nozzles 15 of the recording head 30 to the flushing receiving member 9 as will be described later, whereby flushing operation for recovering ink ejection function is performed.

A vacuum cap device 2 is provided in a non-recording area adjacent to a right side of the recording area. The vacuum cap device 2 performs vacuum-purging operation for sucking ink from the nozzles 15 by way of a vacuum cap (not shown) in order to recover the ink ejection function. The vacuum cap can be closely contacted with and spaced apart from a nozzle surface of the recording head 30, and the vacuum cap, when closely contacted with the nozzle surface, performs vacuum operation (vacuum-purging operation) by a pump (not shown). A wiper 3 having a wiping member for wiping the ink adhering to the nozzle surface having undergone vacuum-purging operation is disposed beside the vacuum cap device 2

The recording head 30 is structured in the same manner as is a recording head described in JP-A-2004-25636. As shown in FIG. 2, the plate-shaped actuator 31 is bonded onto a cavity unit 20 by an adhesive. On top of it, a flexible wiring board 40 having flexibility is electrically joined to an upper surface of the actuator.

The cavity unit 20 is formed by stacking a plurality of plates 21, and the plurality of nozzles 15 are arrayed in the lowermost plate 21. A plurality of pressure chambers 16, each having an elongated shape when viewed from above, are arrayed in the topmost plate 21. The plurality of pressure chambers 16 are at one longitudinal ends thereof in communication with the plurality of nozzles 15 respectively; and are at the other longitudinal ends thereof in communication with manifolds 14 color by color. Ink is distributed from the ink tank 40 to the respective pressure chambers 16 by way of the manifolds 14, to thus reach the nozzles 15 corresponding to the respective pressure chambers 16 and be ejected from the nozzles 15.

The actuator 31 has a laminate structure in which a plurality of piezoelectric ceramics layers 31a, such as a PZT (one layer has a thickness of about 30 μm), are stacked and laminated. Individual electrodes 33 and common electrodes 32, which are common to the plurality of pressure chambers 16, are alternately arranged among the ceramics layers 31a. The individual electrodes 33 are disposed at locations corresponding to the respective pressure chambers 16 in the cavity unit 20. A drive IC chip incorporating a drive circuit 49 is implemented on the flexible wiring board 40 and electrically connected to the electrodes 32 and 33 of the actuator 31. The drive circuit 49 generates a drive pulse for applying a voltage between the common electrodes 32 and the individual electrodes 33, thereby displacing active sections of the ceramics layers 31a sandwiched among the electrodes 32 and 33 to change the volume of the pressure chambers 16. At the time of recording operation, ink is ejected from the nozzles 15 toward the recording sheet P in accordance with a record data signal DATA to be described later, thereby performing recording operation.

At the time of flushing operation for recovering ejection performance of the recording head 30, all of the nozzles 15 eject ink a plurality of times toward the flushing receiving member 4 independently of recording operation while the recording head 30 remains stationary to face the flushing receiving member 4, as will be described later. In order to recover ejection performance before or after recording operation (e.g., a period during which the carriage 9 is accelerated or decelerated), drying prevention driving for vibrating meniscuses of liquid in the nozzles 15 without ejection of ink is performed. By vibration, the ink located in the vicinity of the nozzles 15 is stirred, thereby hindering drying of the meniscuses.

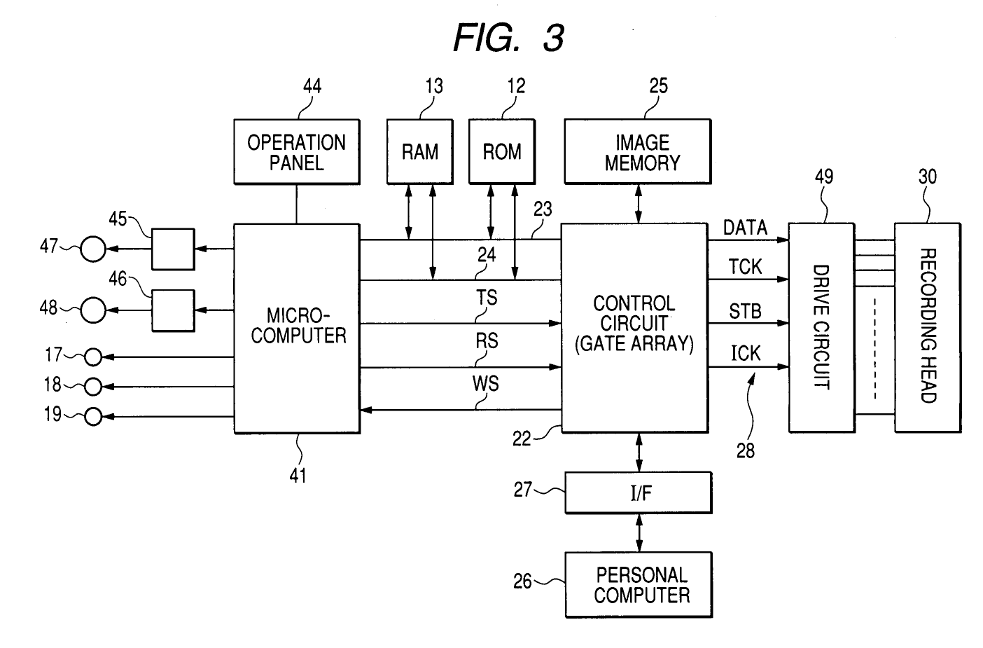

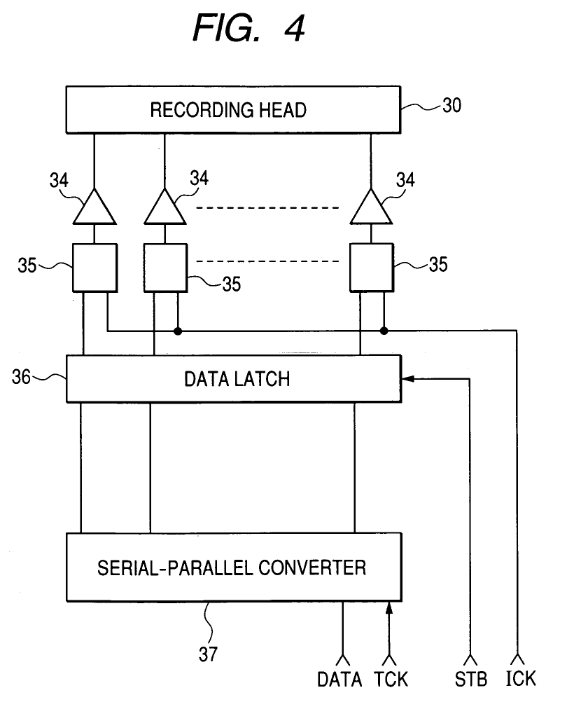

Next, the electrical configuration of the inkjet printer 1 will be described by reference to FIGS. 3 and 4.

FIG. 3 is a block diagram showing the electrical configuration of the inkjet printer 1. As shown in FIG. 3, a controller of the inkjet printer 1 has a CPU (a one-chip microcomputer) 41 for controlling respective sections of the overall inkjet printer 1; a control circuit 22 formed from a gate circuit LSI; ROM 12 storing control programs and drive pulse data ICK for ejecting various types of ink; and RAM 13 for temporarily storing data.

The CPU 41 is connected to an operation panel 44 for inputting various types of commands; a motor driver 45 for driving a carriage motor 47 that causes the carriage 9 to perform a reciprocal scan; and a motor driver 46 for driving a conveyance motor 48 that drives the conveyance device. In addition, the CPU 41 is connected to a paper sensor 17 for detecting presence or absence of a recording sheet P, a home position sensor 18 for detecting that the recording head 3 is located at the home position; and an ink cartridge sensor 19 for detecting that the ink cartridge 5 is in a normally-attached state.

The CPU 41, the ROM 12, the RAM 13, and the control circuit 22 are connected to each other by way of an address bus 23 and a data bus 24. In accordance with a program previously stored in the ROM 12, the CPU 41 generates a record timing signal TS and a control signal RS and transfers the signals TS and RS to the control circuit 22. The control circuit 22 stores in image memory 25 a record data signal transferred from an external device, such as a personal computer 26, by way of an interface 27. The control circuit 22 generates a receipt interruption signal WS from data transferred from the personal computer 26 by way of the interface 27, and transfers the signal WS to the CPU 41. In accordance with the record timing signal TS and the control signal RS, the control circuit 22 generates, from the record data stored in the image memory 25, a record data signal DATA for creating the record data on the recording sheet P, a transfer clock signal TCK synchronized to the record data signal DATA, and a strobe signal STB; and transfers the signals DATA, TCK, and STB to the drive circuit 49. The drive pulse data ICK stored in the ROM 12 include data pertaining to a large droplet and a small droplet, which will be described later, data pertaining to a droplet for flushing purpose, and drive pulse data pertaining to drying prevention driving. The control circuit 22 transfers the drive pulse data ICK to the drive circuit 49.

FIG. 4 shows the internal configuration of the drive circuit 49. The drive circuit 49 has a serial-parallel conversion section 37 for converting into parallel data the record data signal DATA that is serially transferred from a data transfer section (not shown) in the control circuit 22 in synchronism with the transfer clock signal TCK; a data latch 36 for latching the thus-converted parallel data DATA in accordance with the strobe signal STB; a selection circuit 35 for selectively outputting one from the plurality of drive pulse signals ICK in accordance with the parallel data DATA; and a driver 34 for converting the output drive pulse data into a voltage appropriate for driving the actuator 31 and outputting the voltage as a drive pulse signal. The drive pulse signal output from the driver 34 is applied to the individual electrodes 33 of the recording head 30, thereby displacing the actuator 31. The serial-parallel conversion section 37, the data latch 36, the selection circuit 35, and the drier 34 are each prepared in equal number to the nozzles of the recording head 30.

In the inkjet printer, the CPU 41 or the control circuit 22 determines the type of a recording mode in accordance with a recording mode signal set in the record data signal stored in the image memory 25. Each of the record data signals includes pixel size data for instructing a large droplet and a small droplet. When the record data signal is transferred from the control circuit 22 to the drive circuit 49, the selection circuit 35 in the drive circuit 49 selects drive pulse data ICK corresponding to the pixel size instructed by the record data signal, and the driver 34 outputs the drive pulse data ICK as a drive pulse signal to the actuator 31. In the case of a draft mode, all of the drive pulse data are transferred from the personal computer 26 as a record data signal pertaining to a large droplet regardless of pixel size data included in the record data in the personal computer 26.

In accordance with the recording mode or pixel size data in a record data signal pertaining to a droplet to be first ejected among a plurality of recording data signals belonging to one line, the CPU 41 or the control circuit 22 sets conditions for recovery operation control. Specifically, when recovery operation must be started before commencement of recording of the next line, a recording mode of the next line or pixel size data in the record data signal pertaining to a droplet to be first ejected are read, and conditions for recovery operation control are set in accordance with the volume of a droplet to be ejected first. The conditions for recovery operation control include flushing or drying prevention driving, the number of drive operations, a cycle of performing operation, and the like. A plurality of types of recovery operation control are previously stored in the ROM 12 as recovery data signals. One type of recovery data signal among the plurality of recovery data signals is read from the ROM 12 by the control circuit 22 and serially output to the same line as that by way of which the record data signal is output. As a result, the selection circuit 35 in the drive circuit 49 selects the drive pulse data ICK for flushing or drying prevention driving instructed by the recovery data signal, and the driver 34 outputs the thus-selected data as a drive pulse signal to the actuator 31.

A determination as to the volume of the droplet can be made for each of the plurality of nozzles by examining data in the image memory 25. A predetermined recovery data signal is set in areas, corresponding to the respective nozzles, of the serial-parallel conversion section 37, whereby a drive pulse signal for recovering operation can be supplied on a per-nozzle basis.

More detailed specifics of control will be described subsequently.

### First Example

In the present example, as shown in Table 1, the draft mode, a normal mode, and a photographic mode are provided as recording modes. The draft mode is one for recording image data by sampling every other pixel from the image data in the sheet conveyance direction and by using only droplets having a large volume (hereinafter called “large droplets”) in order to speedily perform recording irrespective of gradation or the like. The normal mode is one for recording all pieces of image data by using the large droplets and droplets which are small in volume than the large droplets (hereinafter called “small droplets”) without sampling the data as in the draft mode. The photographic mode is one for performing recording operation by using large droplets and small droplets which are small in volume than the large droplets and the small droplets used in the normal mode, respectively. In Table 1, symbol “−” designates nonuse of ink, thus no volume of a droplet. Designation “LF” denotes a resolution in the direction of conveyance of a sheet, and “CR” designates a resolution in the scanning direction. Designation “Bk” in a “color” field designates black ink; and “CL” designates cyan, magenta, and yellow ink.

The large droplets and the small droplets can be acquired by the number of drive pulses applied to the electrodes corresponding to the pressure chambers 16, the voltage or pulse width of the drive pulses, or combinations thereof.

TABLE 1
VOLUME OF DROPLET (pl)

| RECORDING | | | LARGE | SMALL |
|---|---|---|---|---|
| MODE | RESOLUTION | COLOR | DROPLET | DROPLET |
| DRAFT MODE | LF 150 dpi | Bk | 24 | — |
| (DRIVEN AT | CR 600 dpi | CL | 16 | — |
| 26 kHz) | | | | |
| NORMAL | LF 300 dpi | Bk | 24 | 4 |
| MODE (DRIVEN | CR 600 dpi | CL | 16 | 3 |
| AT 26 kHz) | | | | |
| PHOTO- | LF 1200 dpi | Bk | — | — |
| GRAPHIC | CR 2400 dpi | CL | 10 | 1.5 |
| MODE | | | | |
| (DRIVEN AT | | | | |
| 26 kHz) | | | | |

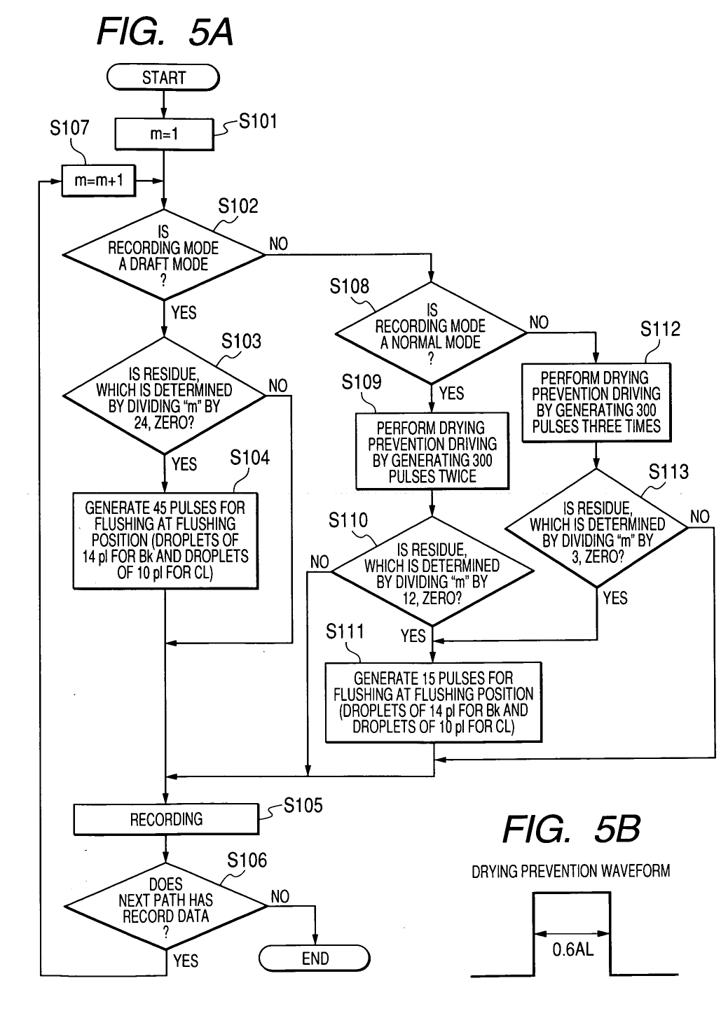

Tables 2 and 3 show drying prevention driving and flushing operations performed in the respective recording modes. As shown in FIG. 5B, the drive pulse signal used for drying prevention driving is set to one-half of a period at which a pressure wave, induced in ink in the pressure chamber as a result of the displacement of the actuator at the rise or fall of the drive pulse signal, varies. Namely, the drive signal is set to 0.6 AL where a time consumed when the pressure wave propagates one way through the inside of ink flow channel of the recording head including the pressure chamber is taken as AL. This drive pulse signal vibrates the meniscus of the ink in the nozzle 15 but does not cause ejection of ink.

In relation to a drive pulse signal used for performing flushing, the volume of a droplet ejected by one drive pulse signal is set to 14 pl for black ink and 10 pl for color ink.

TABLE 2
DRYING PREVENTION DRIVING

| | | NUMBER OF | |
|---|---|---|---|
| | | TIMES DRIVING | |
| RECORDING | NUMBER OF | IS PERFORMED | INTERVAL |
| MODE | PULSES | (CYCLE) | (PERIOD) |
| DRAFT MODE | 0 | 0 | 0 |
| NORMAL MODE | 300 | 2 | 100 |
| PHOTOGRAPHIC | 300 | 3 | 100 |
| MODE | | | |

TABLE 3
FLUSHING

| | NUMBER OF | FREQUENCY (PER |
|---|---|---|
| | PULSES | LINE) |
| RECORDING MODE | (Bk 14 pl, CL 10 pl) | A4-SIZED SHEET |
| DRAFT MODE | 45 PULSES | 24 |
| NORMAL MODE | 15 PULSES | 12 |
| PHOTOGRAPHIC MODE | 15 PULSES | 3 |

Specifics of recovery operation control will be described by reference to FIG. 5A. First, when operation is started, the number of lines to be recorded “m” is taken as one (step S101), and then it is determined whether or not the recording mode is a draft mode (step S102). When the recording mode is the draft mode, flushing is performed every time 24 lines are recorded (scanned). Therefore, it is determined whether or not a residue obtained by dividing the number of lines to be recorded “m” by 24 is zero (step S103). When the residue is zero, flushing must be performed. Hence, the recording head is moved to the flushing position, where flushing by 45 pulses is performed (step S104).

After completion of flushing, recording of one line is performed (step S105). When the residue is determined not to be zero in step S103, recording is performed without performing flushing (step S105). After completion of recording operation, it is determined whether or not the next data path (a data line) has record data (step S106). When the next data path has record data, the number of lines “m” is rewritten to m+1 (step S107). Namely, one is added to the number of lines, and processing returns to step S102. On the other hand, when the next data path does not have record data, processing ends.

When the recording mode is determined not to be the draft mode in step S102, it is determined whether or not the recording mode is a normal mode (step S108).

In the case of the normal mode, drying prevention driving is performed by generating 300 pulses twice at an interval of 100 μsec (step S109). Subsequently, flushing is performed every time 12 lines are recorded, and hence it is determined whether or not the residue obtained by dividing the number of lines to be recorded “m” by 12 is zero (step S110). When the residue is zero, the recording head is moved to the flushing position, where flushing operation is performed by generating 15 pulses (step S111). When the residue is not zero, processing proceeds to step S105, where recording of one line is performed.

When the recording mode is determined not to be the normal mode in step S108, the recording mode is determined to be the photographic mode, and hence drying prevention driving operations is performed by generating 300 pulses three times at an interval of 100 μsec (step S112). Subsequently, when the recording mode is the photographic mode, flushing is performed every time three lines are recorded. Therefore, it is determined whether or not the residue obtained by dividing the number of lines to be recorded “m” by three is zero (step S113). When the residue is zero, the recording head is moved to the flushing position, where flushing is performed by generating 15 pulses (step S113). When the residue is not zero, processing proceeds to step S105, where recording of one line is performed.

In the first example, the draft mode and the photographic mode differ from each other in terms of the volume of droplets used for recording. Moreover, the draft mode and the photographic mode also differ from each other in terms of the drive pulse signal applied to the actuator during recovery operation. In the case of the draft mode, the drive pulse signal is a drive pulse signal for flushing purpose. However, in the case of the photographic mode, the drive pulse signal is a drive pulse signal for drying prevention driving purpose. The draft mode and the photographic mode differ from each other in terms of the number of droplets ejected for flushing and the frequency of flushing operation.

Moreover, the normal mode and the photographic mode also differ from each other in terms of the number of times drying prevention driving is repeated and the frequency of flushing.

### Second Example

The second example is identical with the first example in terms of the recording modes and the volumes of droplets used in the respective recording modes. Moreover, the second example is also identical with the first example in terms of the drive pulse signal used for drying prevention driving and the drive pulse signal used for flushing. When a droplet to be first ejected in accordance with record data signal in ink droplet ejection control subsequent to each recovery operation is of small size, drying prevention driving and flushing are performed under conditions provided in Tables 2 and 3. When the droplet is of large size, drying prevention driving and flushing are performed under conditions provided in Tables 4 and 5. Specifically, when the droplets are large, the ink is resistant to drying. Therefore, the number of pulses generated for drying prevention driving is decreased, and the number of droplets ejected for flushing and the size of a droplet used for flushing, are reduced.

TABLE 4
DRYING PREVENTION DRIVING

| | | NUMBER OF | |
|---|---|---|---|
| | | TIMES DRIVING | |
| RECORDING | NUMBER OF | IS REPEATED | INTERVAL |
| MODE | PULSES | (CYCLE) | (PERIOD) |
| DRAFT MODE | 0 | 0 | 0 |
| NORMAL MODE | 100 | 2 | 100 |
| PHOTOGRAPHIC | 100 | 3 | 100 |
| MODE | | | |

TABLE 5
FLUSHING

| | NUMBER OF PULSES | FREQUENCY |
|---|---|---|
| | DM (Bk 14 pl, CL 10 pl) | (PER LINE) |
| RECORDING MODE | NM, PM (Bk 7 pl, CL 5 pl) | A4-SIZED SHEET |
| DRAFT MODE | 45 PULSES | 24 |
| NORMAL MODE | 10 PULSES | 12 |
| PHOTOGRAPHIC | 10 PULSES | 3 |
| MODE | | |

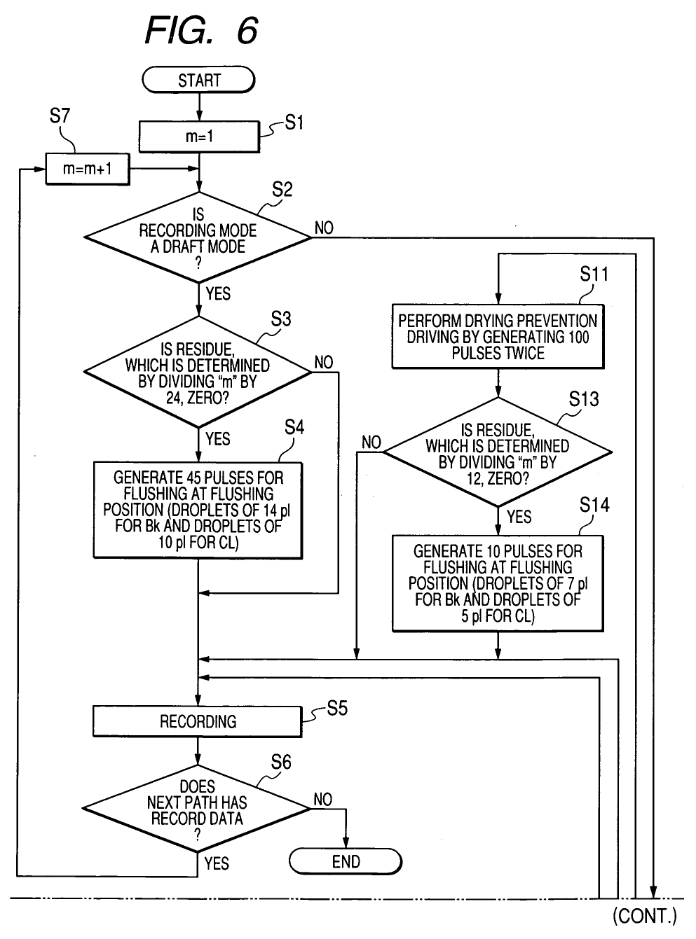

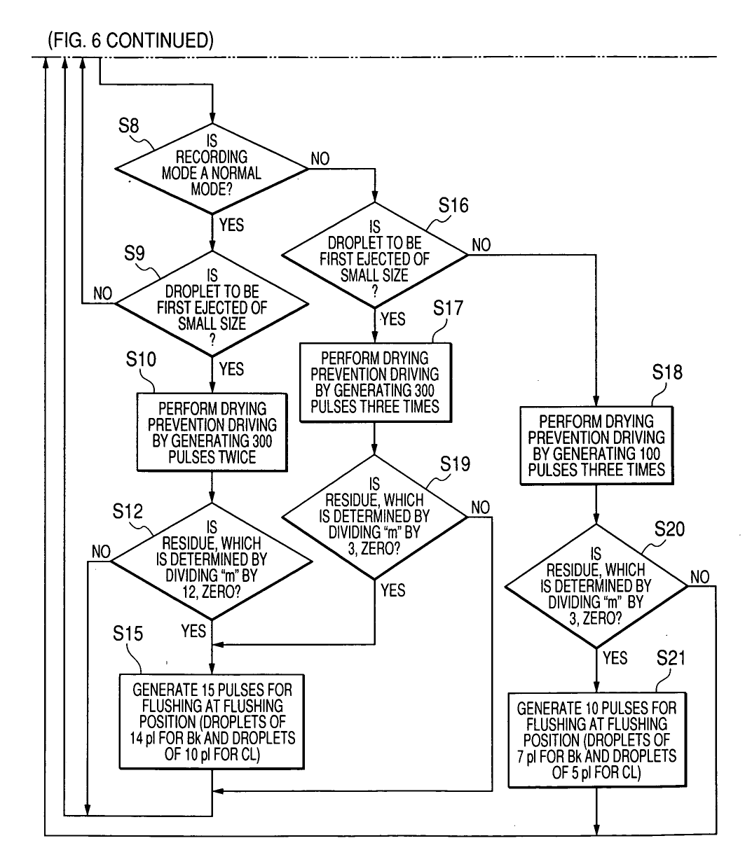

Specifics of control operation are as shown in FIG. 6. Specifically, when control is started, the number of lines to be recorded “m” is taken as one (step S1) and then it is determined whether or not the recording mode is a draft mode (step S2).

In the case of the draft mode, 45 droplets are ejected for flushing every 24 lines (steps S3 and S4) as with the case of the first example. The operation is repeated until record data pertaining to the draft mode become empty (S5 and S6). As shown in Table 1, recording is performed in the draft mode by using only large droplets resistant to drying, and hence drying prevention driving is not carried out prior to flushing as shown in Table 4. In addition, the volume of a droplet ejected for flushing is 14 pl for black ink and 10 pl for color ink as shown in Table 5.

In the case of the normal mode (No in step S2 and Yes in step S8), it is determined whether or not a droplet to be first ejected is of small size (step S9). When the droplet is of small size, drying prevention driving is performed by generating 300 pulses twice at an interval of 100 μsec (step S10). When the droplet is not of a small size, the droplet is determined to be large. Since the large droplets are resistant to drying, the number of drying prevention driving operations is reduced, and drying prevention driving is performed by generating 100 pulses twice at an interval of 100 μsec (step S11). In the case of the normal mode, after the twice drying prevention driving operations (steps S10 and S11), flushing is performed every time 12 lines are recorded (steps S12 and S13) as in the case of the first example. At that time, flushing is performed by generating 15 pulses when the droplet to be first ejected is of small size (step S15), and flushing is performed by generating 10 pulses when the droplet is of large size (step S14). Subsequently, recording is performed (step S5).

When the recording mode is determined not to be the normal mode in step S8, the recording mode is determined to be the photographic mode. Likewise, it is determined whether or not the droplet to be first ejected is of small size (step S16). When the droplet is of small size, drying prevention driving is performed by generating 300 pulses three times at an interval of 100 μsec (step S17). When the droplet is not of a small size, the droplet is determined to be large. Hence, drying prevention driving is performed by generating 100 pulses three times at an interval of 100 μsec (step S18). In the case of the photographic mode, after drying prevention driving (steps S17 and S18), flushing is performed every time three lines are recorded (steps S19 and S20). At that time, flushing is performed by generating 15 pulses when the droplet to be first ejected is of small size (step S15), and flushing is performed by generating 10 pulses when the droplet is of large size (step S21). Subsequently, recording is performed (step S5). In these flushing operations (steps S14, S15, and S21), the volume of each of 15 droplets of black ink ejected for flushing is 14 pl (S15); the volume of each of 15 droplets of color ink ejected for flushing is 10 pl (S15); the volume of each of 10 droplets of black ink ejected for flushing is 7 pl (S14, S21); and the volume of each of 10 droplets of color ink ejected for flushing is 5 pl (S14, S21).

### Third Example

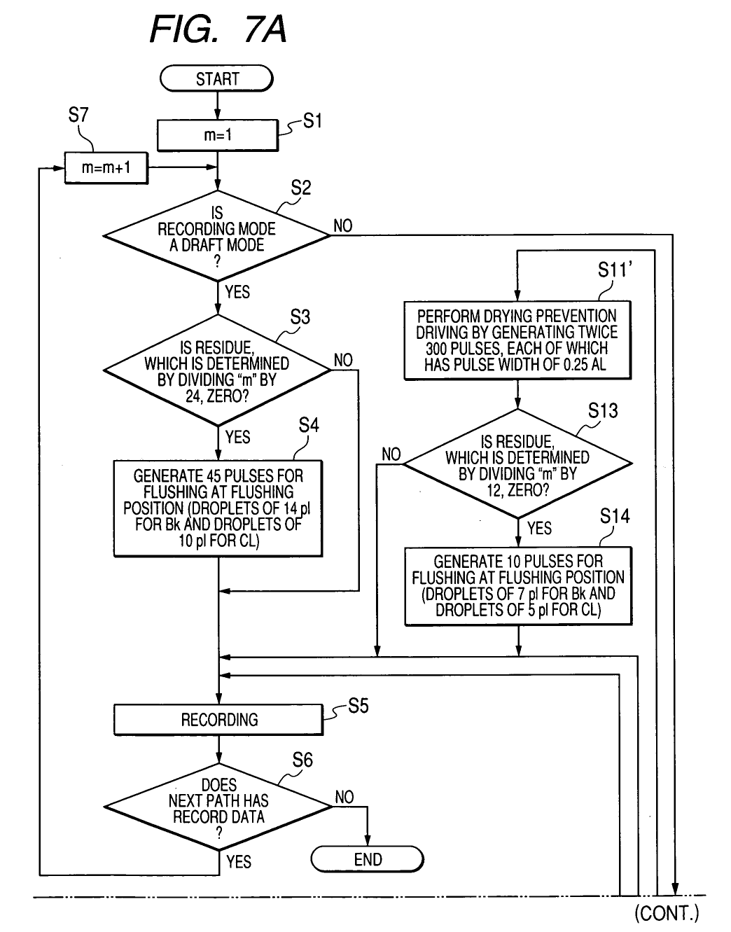

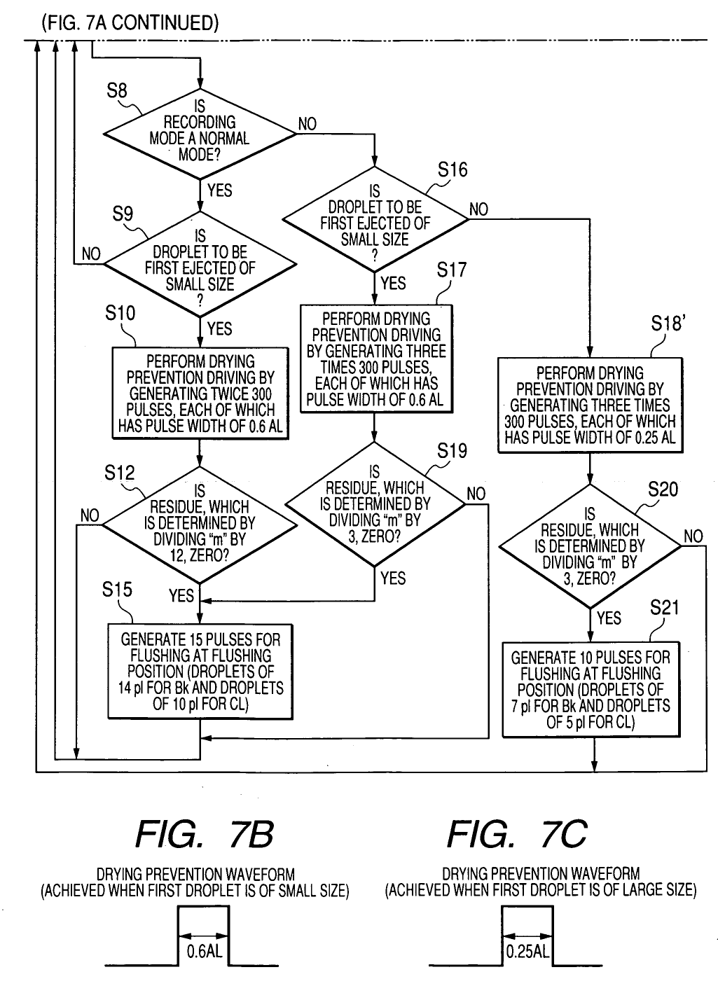

In the control for drying prevention driving in the first and second examples, the drive pulse signal for the small droplet and the drive pulse signal for the large droplet are set to be the same pulse width of 0.6 AL, and the number of pulses is changed. Instead, as shown in FIG. 7A, a pulse width can be changed with the number of pulses unchanged (the third example is identical with the second example except processing pertaining to steps S11′ and S18′). Specifically, when the droplet is of small size, a pulse width of 0.6 AL shown in FIG. 7B is used (steps S10 and S17). When the droplet is of large size, a pulse width of 0.25 AL shown in FIG. 7C is used (steps S11′ and S18′). Namely, the third example is identical with the first example in that drying prevention driving is performed in the normal mode by generating 300 pulses twice at an interval of 100 sec and in that drying prevention driving is performed in the photographic mode by generating 300 pulses three times at an interval of 100 μsec. However, the third example is different from the first example in that the pulse width is 0.6 AL for the small droplet and the pulse width is 0.25 AL for the large droplet. In the case of the large droplet, the pulse width is made small to reduce the magnitude of vibration of the meniscus and the time during which a voltage is applied, thereby saving energy consumption.

### Fourth Example

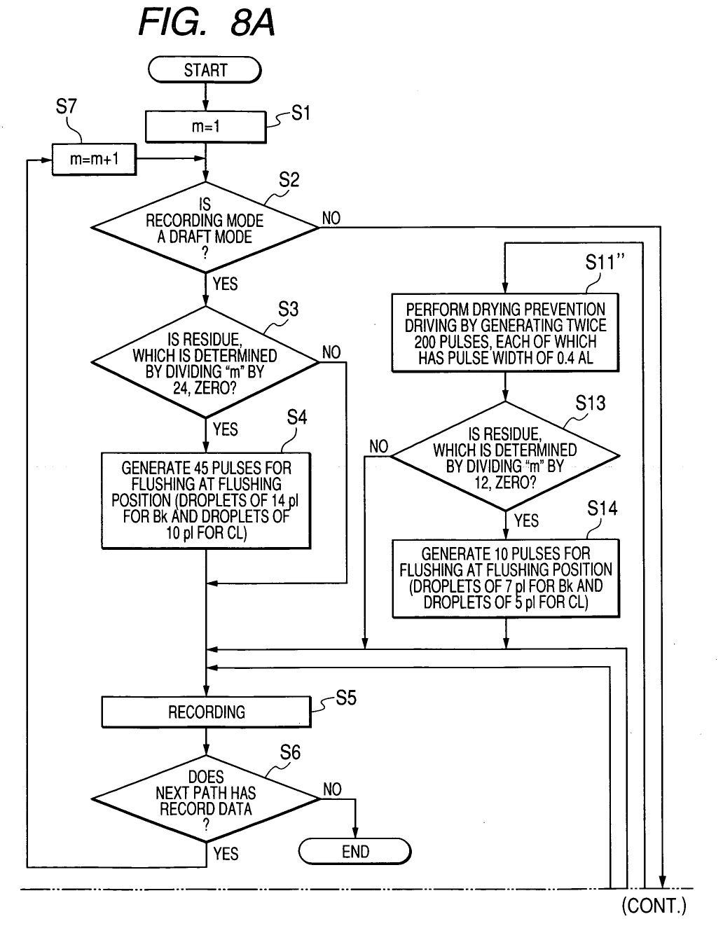

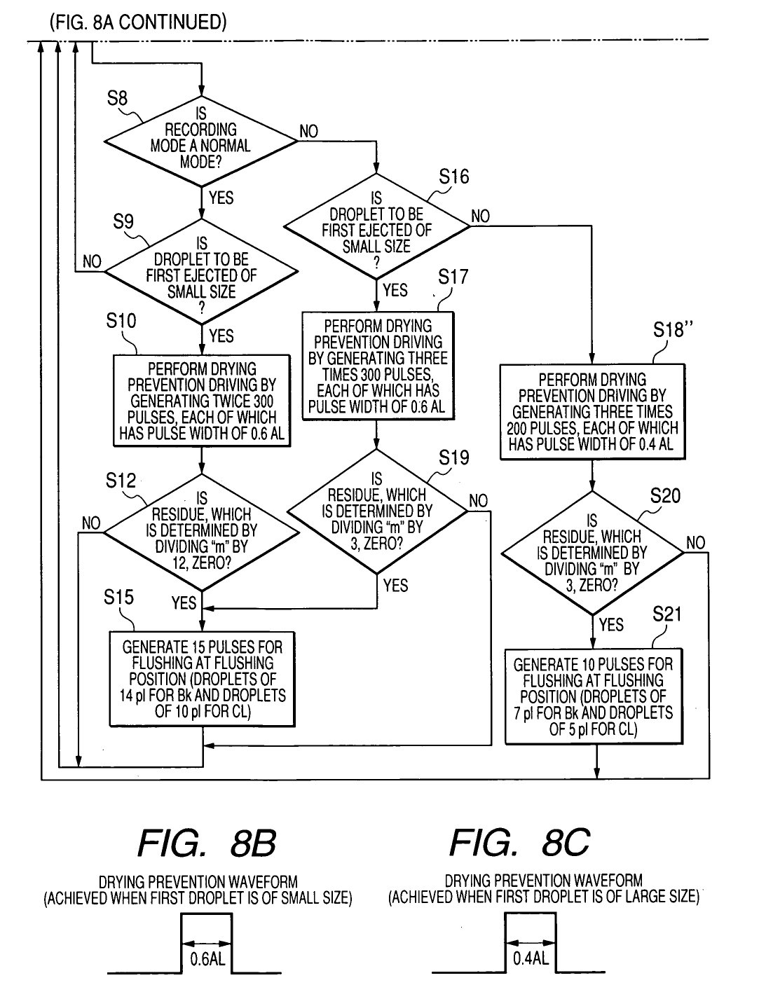

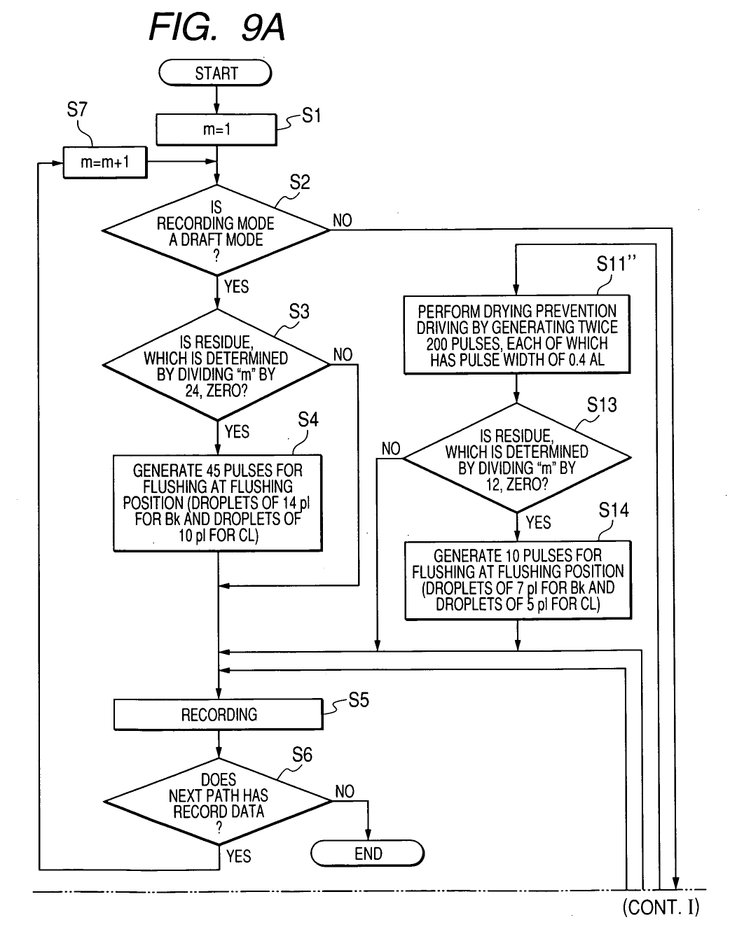

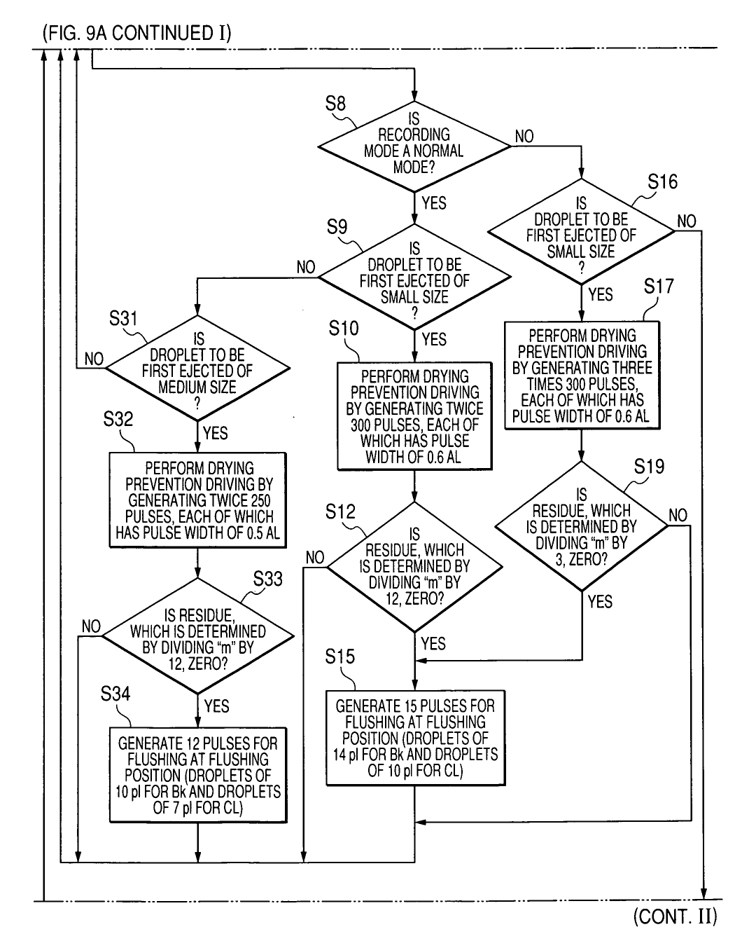

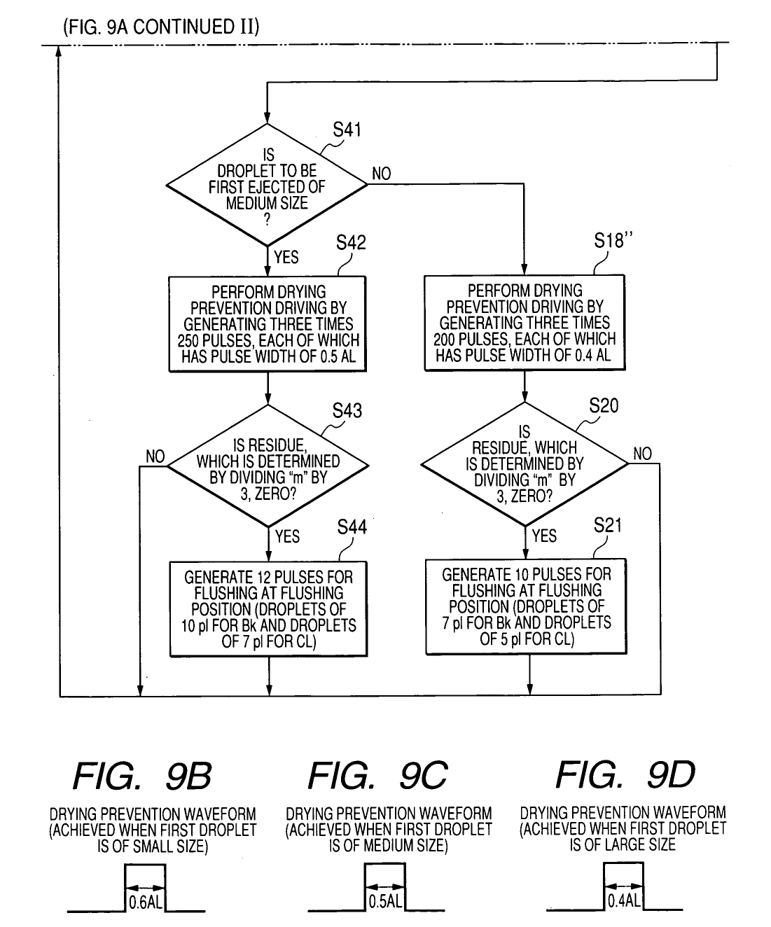

Both the number of pulses and the pulse width can also be changed as shown, for example, in FIG. 8A (the fourth example is identical with the second example except processing pertaining to steps S11″ and S18″). When the droplet to be first ejected is of small size, the waveform of drying prevention driving as shown in FIG. 8B is used. When the droplet is of large size, the waveform as show in FIG. 8C is used. Further, drying prevention driving for the large droplet is performed as shown in Table 6. Therefore, in the case of the normal mode (S8, Yes), when the droplet is of small size, 300 pulses, each of which has a width of 0.6 AL, are generated twice at an interval of 100 μsec (step S10), and when the droplet is of large size, 200 pulses, each of which has a width of 0.4 AL, are generated twice at an interval of 100 μsec (step S11″). In the case of the photographic mode (S8, No), when the droplet is of small size, 300 pulses, each of which has a width of 0.6 AL, are generated three times at an interval of 100 μsec (step S17), and when the droplet is of large size, 200 pulses, each of which has a width of 0.4 AL, are generated three times at an interval of 100 μsec (step S18″).

TABLE 6
DRYING PREVENTION DRIVING

| | | NUMBER OF | |
|---|---|---|---|
| | | TIMES | |
| | NUMBER OF | DRIVING | |
| RECORDING | (GENERATED) | IS REPEATED | INTERVAL |
| MODE | PULSES | (CYCLE) | (PERIOD) |
| DRAFT MODE | 0 | 0 | 0 |
| NORMAL MODE | 200 | 2 | 100 |
| PHOTOGRAPHIC | 200 | 3 | 100 |
| MODE | | | |

### Fifth Example

The previously-described examples correspond to the case where two types of droplets; namely, the small droplet and the large droplet, are available. However, the number of sizes of droplets is not limited to two. The present invention can be applied similarly, so long as droplets of plural sizes can be selectively ejected. In the fifth example to be described next, an explanation is given to a case where there are droplets having three types of volumes as shown in Table 7; namely, the small droplet, the large droplet, and a medium droplet which is the medium between the large and small droplets in terms of a volume.

TABLE 7

| | | | VOLUME OF DROPLET (pl) | | |
|---|---|---|---|---|---|
| RECORDING | | | LARGE | MEDIUM | SMALL |
| MODE | RESOLUTION | COLOR | DROPLET | DROPLET | DROPLET |
| DRAFT MODE | LF 150 dpi | Bk | 24 | — | — |
| | CR 600 dpi | CL | 16 | — | — |
| NORMAL MODE | LF 300 dpi | Bk | 24 | 14 | 4 |
| | CR 600 dpi | CL | 16 | 10 | 3 |
| PHOTOGRAPHIC | LF 1200 dpi | Bk | — | — | — |
| MODE | CR 2400 dpi | CL | 10 | 5 | 1.5 |

The present example is identical with the foregoing examples in that each of recovery operations (i.e. drying prevention driving and flushing) is performed under the conditions provided in Tables 2 and 3 when the record data signal shows that the droplet to be first ejected under ink droplet ejection control subsequent to the recovery operation is of small size, and in that drying prevention driving and flushing are performed under the conditions provided in Tables 6 and 5 when the record data signal shows that the droplet to be first ejected under ink droplet ejection control subsequent to the recovery operation is of large size. However, when the droplet is of medium size, each of the recovery operations (i.e., drying prevention driving and flushing) is performed under conditions, which are the medium between the conditions for the large droplet and the conditions for the small droplet, as shown in Tables 8 and 9. As the volume of a droplet to be first ejected increases in sequence of the small droplet, the medium droplet, and the large droplet, the droplets become more resistant to drying in this sequence. Therefore, as the volume of a droplet to be first ejected becomes greater, the number of pulses to be generated for drying prevention driving and the pulse width of the drive waveform are reduced. In this connection, the number of droplets to be ejected for flushing and the size of droplets for flushing are also reduced.

TABLE 8
DRYING PREVENTION DRIVING

| | | NUMBER OF | |
|---|---|---|---|
| | | TIMES DRIVING | |
| RECORDING | NUMBER OF | IS REPEATED | INTERVAL |
| MODE | PULSES | (CYCLE) | (PERIOD) |
| DRAFT MODE | 0 | 0 | — |
| NORMAL MODE | 250 | 2 | 100 |
| PHOTOGRAPHIC | 250 | 3 | 100 |
| MODE | | | |

TABLE 9
FLUSHING

| | NUMBER OF PULSES | FREQUENCY |
|---|---|---|
| RECORDING | DM (Bk 14 pl, CL 10 pl) | (PER LINE) |
| MODE | NM, PM (Bk 10 pl, CL 7 pl) | A4-SIZED SHEET |
| DRAFT MODE | 45 PULSES | 24 |
| NORMAL MODE | 12 PULSES | 12 |
| PHOTOGRAPHIC | 12 PULSES | 3 |
| MODE | | |

In the present example, the waveform of drying prevention driving under control shown in FIG. 8A has a pulse width of 0.6 AL for a small droplet, a pulse width of 0.5 AL for a medium droplet, and a pulse width of 0.4 AL for a large droplet as shown in FIGS. 8B to 8D.

When operation is started, similarly to the first example, the number of lines to be recorded “m” is taken as one (step S1), and then it is determined whether or not the recording mode is a draft mode (step S2). When the recording mode is the draft mode, flushing is performed every time 24 lines are recorded (steps S3 and S4). The operation is repeated until record data pertaining to the draft mode become empty (S5 and S6).

When the recording mode is determined not to be the draft mode in step S2, it is determined whether or not the recording mode is a normal mode (step S8).

In the case of the normal mode, it is determined whether or not a droplet to be first ejected is of small size (step S9). When the droplet is of small size, drying prevention driving is performed by generating 300 pulses, each of which has a pulse width of 0.6 AL, twice at an interval of 100 μsec (step S1). When the droplet is not of a small size, it is determined whether or not the droplet is of medium size (step S31). When the droplet is of medium size, the droplet is more resistant to drying than is the small droplet but is liable to drying than is the large droplet. Therefore, drying prevention driving is performed by generating 250 pulses, each of which has a pulse width of 0.5 AL, twice at an interval of 100 μsec (step S32). When the droplet is not of a medium size, the droplet is determined to be of large size. Hence, drying prevention driving is performed by generating 200 pulses, each of which has a pulse width of 0.4 AL, twice at an interval of 100 μsec (step S11″).

In the case of the normal mode, after drying prevention driving (steps S10, S32, and S11″), flushing is performed every time 12 lines are recorded (steps S12, S15, S33, S34, S13, and S14).

When the recording mode is determined not to be the normal mode in step S8, the recording mode is determined to be a photographic mode. Likewise, it is determined whether or not the droplet to be first ejected is of small size (step S16). When the droplet is of small size, drying prevention driving is performed by generating 300 pulses, each of which has a pulse width of 0.6 AL, three times at an interval of 100 μsec (step S17). When the droplet is not of small size, it is determined whether or not the droplet is of medium size (step S41). When the droplet is of medium size, drying prevention driving is performed by generating 250 pulses, each of which has a pulse width of 0.5 AL, three times at an interval of 100 μsec (step S42). When the droplet is not of medium size, the droplet is determined to be of large size. Hence, drying prevention driving is performed by generating 200 pulses, each of which has a pulse width of 0.4 AL, three times at an interval of 100 μsec (step S18″).

In the case of the photographic mode, after drying prevention driving (steps S17, S42, and S18″), flushing is performed every time three lines are recorded (steps S19, S15, S43, S44, S20, and S21). In the flushing operations (steps S15, S34, S14, S44, and S21), 15 pulses are generated during flushing for the small droplet (S15); 12 pulses are generated during flushing for the medium droplet (S34, S44); and 10 pulses are generated during flushing for the large droplet (S14, S21). In these flushing operations (steps S15, S34, S14, S44, and S21), in the case of black ink, the volume of droplets ejected for flushing is 14 pl for the small droplet (S15), 10 pl for the medium droplet (S34, S44), and 7 pl for the large droplet (S14, S21). In the case of color ink, the volume of droplets ejected for flushing is 10 pl for the small droplet (S15), 7 pl for the medium droplet (S34, S44), and 5 pl for the large droplet (S14, S21). After flushing operation, recording is performed (step S5), and this process is repeated until the number of lines to be recorded reach a predetermined number (step S6).

In each of the examples, drying prevention driving is performed before recording of every line. Instead, drying prevention driving may also be performed at a predetermined period, for example, every other line or every three or more lines. When drying prevention driving is performed every line or at a predetermined period, the next operation, such as recording, is performed immediately after drying prevention driving unless flushing is to be performed at the same timing at which the drying prevention driving is to be performed. When a timing at which flushing is to be performed and a timing at which the drying prevention driving is to be performed are coincident with each other, drying prevention driving is preferably performed while the head is being moved to the flushing position, and thereafter flushing is performed at the flushing position where the head faces the flushing receiving member 4.

The number of pulses for drying prevention driving, the pulse width for the drying prevention driving, the number of pulses for flushing, and the period of performing flushing are not limited to the numerals described in connection with the respective examples. They can be determined appropriately according to the type of ink, a nozzle size, or the like. Moreover, the pulse width of the drive pulse signal used for flushing may also be changed according to the volume of droplet as in the case of drying prevention driving.

The forgoing description is directed to the case where a droplet ejection device is embodied as an inkjet printer. It should be noted that the present invention is not limited to the inkjet printer and can also be embodied as various types of a droplet ejection device, such as a device for ejecting a coloring liquid as minute droplets to form, for example, a color filter of a liquid crystal device, a device for ejecting a conductive liquid to form a wiring pattern, etc.

As discussed above, the present invention can provide at least the following illustrative, non-limiting embodiments.

(1) A droplet ejection device that performs, using a control unit, recording control for ejecting a liquid as droplets to a medium from a nozzle of a recording head by driving an actuator in accordance with a drive pulse signal corresponding to ejection data and recovery control for performing recovery operation to recover ejection performance of the recording head by driving the actuator, wherein the recording control controls the recording head to selectively eject plural types of droplets having different volumes from the nozzle of the recording head in accordance with the ejection data, and the control unit controls a drive pulse signal applied to the actuator by setting a condition for the recovery control in accordance with a volume of a droplet to be first ejected in accordance with the ejection data under the recording control subsequent to the recovery operation.

According to the liquid ejection device of (1), the control unit controls the drive pulse signal applied to the actuator by setting the condition for the recovery control in accordance with the volume of the droplet to be first ejected in accordance with the ejection data under the recording control subsequent to the recovery operation. Hence, wasteful recovery operation is avoided. Therefore, liquid consumption, and power consumption induced by driving the actuator are reduced.

(2) The droplet ejection device of claim 1, in which the condition for the recovery control is set for each nozzle in accordance with the volume of the droplet to be first ejected from each nozzle under the recording control subsequent to the recovery operation, to thereby control the drive pulse signal applied to the actuator.

According to the liquid ejection device of (2), the condition for the recovery control is set for each nozzle in accordance with the volume of the droplet to be first ejected from each nozzle under the recording control subsequent to the recovery operation. Hence, even when the volume of the droplet to be first ejected changes from nozzle to nozzle, control is performed on a per-nozzle basis, thereby avoiding wasteful recovery operation in each nozzle.

(3) The droplet ejection device of (1) or (2), in which recovery control includes first recovery control for performing, at a first period, a first recovery operation for applying to the actuator a pulse group including plural non-ejection drive pulse signals that apply only vibration to a liquid meniscus in the vicinity of the nozzle to such an extent as not to eject any droplets from the nozzle, and the condition for the first recovery control includes at least one of the number of pulses of the non-ejection drive pulse signals, a pulse width of the non-ejection drive pulse signal, and the number of the pulse groups.

According to the liquid ejection device of (3), the number of the pulses of the non-ejection drive pulse signals, the pulse width of the non-ejection drive pulse signal, or the number of the pulse groups is set in accordance with the volume of the droplet to be first ejected under the recording control subsequent to recovery operation, and therefore power consumption induced by wasteful driving can be reduced.

(4) The droplet ejection device of any one of (1) to 3, in which the recovery control includes second recovery control for performing, at a second period, second recovery operation performing flushing that forcefully ejects the liquid from all nozzles of the recording head to a liquid receiving member, and the conditions for the second recovery control includes the number of flushing.

According to the liquid ejection device of (4), the number of flushing is set in accordance with the volume of the droplet to be first ejected under the recording control subsequent to the recovery operation, and therefore wasteful liquid consumption can be reduced.

(5) The droplet ejection device of (3), in which for the first recovery control, the control unit sets the number of pulses of the non-ejection drive pulse signals, the number of pulse groups or the pulse width of the non-ejection drive pulse signal to be smaller in accordance with the volume of the droplet to be first ejected as the volume of the droplet becomes greater.

According to the liquid ejection device of (5), the droplet become less susceptible to drying as the volume of the droplet to be first ejected becomes greater, and therefore by using this power consumption induced by wasteful driving can be reduced.

(6) The droplet ejection device of (4), in which for second recovery control, the control unit sets the number of flushing to be smaller in accordance with the volume of the droplet to be first ejected as the volume of the droplet becomes greater.

According to the liquid ejection device of (6), the droplet become less susceptible to drying as the volume of the droplet to be first ejected becomes greater, and therefore by using this wasteful liquid consumption can be reduced.

(7) The droplet ejection device of (1) or (2), in which the recovery control includes first recovery control for performing, at a first period, a first recovery operation for applying to the actuator a pulse group including plural non-ejection drive pulse signals that apply only vibration to a liquid meniscus in the vicinity of the nozzle to such an extent as not to eject any droplets from the nozzle and second recovery control for performing, at a second period, second recovery operation performing flushing that forcefully ejects the liquid to a liquid receiving member from all nozzles of the recording head, and, when a timing at which the first recovery operation is to be performed coincides with a timing at which the second recovery operation is to be performed, the second recovery control is performed after first recovery control.

According to the liquid ejection device of (7), since the second recovery control is performed after first recovery control, it is possible to eliminate such an ejection failure that flushing is disturbed by drying. An effect of recovery of ejection performance can be enhanced.

(8) The droplet ejection device of (7), in which the droplet ejection device further includes a carriage which mounts thereon the recording head and which can reciprocally scan, in a widthwise direction of a medium, a recording area where the liquid is to be ejected as droplets to the medium from the nozzle of the recording head, and the control unit is configured to perform the first recovery control when the carriage is being moved toward a recovery position outside the recording area and to perform the second recovery control when the carriage is located at the recovery position.

According to the liquid ejection device of (8), appropriate recovery operation is performed in accordance with whether the carriage is in the recording area or at the recovery position, whereby recovery operation is efficiently performed.

What is claimed is:

1. A droplet ejection device comprising:
an ejection head having an actuator and a nozzle;
an interface configured to receive data; and
a controller configured to (a) execute, based on the received data, ejection control in which liquid droplets having respective different volumes are selectively ejected from the nozzle to a medium by driving the actuator and (b) execute recovery control in which ejection performance of the recording head is recovered by driving the actuator, wherein
the controller is configured to (c) determine, based on the received data, a volume of a droplet to be first ejected from the nozzle under the ejection control subsequent to the recovery control, and (d) set, based on the determined volume, a condition for driving the actuator to execute the recovery control.

2. The droplet ejection device according to claim 1, wherein the controller is configured to determine the volume of the droplet in a nozzle-by-nozzle basis and set the condition for driving the actuator in the nozzle-by-nozzle basis.

3. The droplet ejection device according to claim 1, wherein the recovery control includes first recovery control in which a first recovery is performed at a first period by applying a pulse group including plural non-ejection drive pulses to the actuator to vibrate a liquid meniscus in the vicinity of the nozzle to such an extent as not to eject any droplet from the nozzle, and
the condition for driving the actuator to execute the first recovery control includes at least one of the number of the pulses, a pulse width of the pulses and the number of the pulse groups.

4. The droplet ejection device according to claim 1, wherein the recovery control includes second recovery control in which flushing is performed at a second period by applying a pulse group including plural ejection drive pulses to the actuator in a state where the ejection head faces a liquid receiving member other than the medium, and
the condition for driving the actuator to execute the second recovery control includes the number of the pulses.

5. The droplet ejection device according to claim 3, wherein the controller is configured to set the condition for driving the actuator to execute the first control so that as the determined volume is larger, the number of the pulses, the pulse width of the pulses and/or the number of pulse groups is smaller.

6. The droplet ejection device according to claim 4, wherein the controller is configured to set the condition for driving the actuator to execute the second recovery control so that as the determined volume is larger, the number of the pulses is smaller.

7. The droplet ejection device according to claim 1, wherein the recovery control includes:
first recovery control in which a first recovery is performed at a first period by applying a pulse group including plural non-ejection drive pulses to the actuator to vibrate a liquid meniscus in the vicinity of the nozzle to such an extent as not to eject any droplet from the nozzle; and
second recovery control in which flushing is performed at a second period different from the first period by applying a pulse group including plural ejection drive pulses to the actuator in a state where the ejection head faces a liquid receiving member other than the medium, and,
the controller is configured to perform the second recovery after first recovery when a timing at which the first recovery is to be performed and a timing at which the second recovery is to be performed are coincides with each other.

8. The droplet ejection device according to claim 7, wherein the controller is configured to perform to the first recovery while moving the ejection head from an ejection area of the medium, where the liquid droplets are to be ejected under the ejection control, toward a recovery position located outside the ejection area, and perform the second recovery when the ejection head is located at the recovery position.

9. An inkjet printer comprising:
a recording head having an actuator and a nozzle;
an interface configured to receive recording data and selected one of available options including a draft mode, a normal mode and a photographic mode; and
a controller configured to (a) execute, based on the recording data and the selected option, recording control in which ink droplets having respective different volumes are selectively ejected from the nozzle to a recording medium by driving the actuator, (b) execute recovery control in which ejection performance of the recording head is recovered by driving the actuator, and (c) set, based on the selected option, a condition for driving the actuator to execute the recovery control.
